(19) United States
(12) Patent Application Publication
(10) Pub. No.: US 2011/0237699 A1
(43) Pub. Date: Sep. 29, 2011

(54) PROCESS FOR PRODUCING MOLDED FOAMS FROM MELAMINE/FORMALDEHYDE CONDENSATION PRODUCTS

(75) Inventors: Tobias Heinz Steinke, Speyer (DE); Klaus Hahn, Kirchheim (DE); Horst Baumgartl, Mainz (DE); Jens-Uwe Schierholz, Bensheim (DE); Bettina Wester, Mannheim (DE); Christof Möck, Mannheim (DE); Bernhard Vath, Mannheim (DE); Peter Nessel, Ludwigshafen (DE)

(73) Assignee: BASF SE, Ludwigshafen (DE)

(21) Appl. No.: 13/069,967

(22) Filed: Mar. 23, 2011

Related U.S. Application Data
(60) Provisional application No. 61/316,839, filed on Mar. 24, 2010.

(51) Int. Cl. C08G 12/32; C08J 9/36

(52) U.S. Cl. 521/188

(57) ABSTRACT

Process for producing molded foams from melamine/formaldehyde condensation products by subjecting melamine/formaldehyde precondensates to foaming under reduced pressure and subsequent irradiation.

The present invention relates to the production of molded foams from melamine/formaldehyde condensation products.

EP-37 470 discloses the foaming and curing of melamine/formaldehyde condensation products by microwave radiation. Foaming takes place advantageously under reduced pressure, preferably at 400 to 900 mbar.

The melamine/formaldehyde resin foams obtainable thereby leave something to be desired.

It was an object of the present invention, therefore, to remedy the deficiencies stated above.

Found accordingly has been a new and improved process for producing molded foams from melamine/formaldehyde condensation products, which comprises subjecting melamine/formaldehyde precondensates to foaming under reduced pressure and subsequent irradiation.

The process of the invention can be carried out as follows:

A solution, emulsion, dispersion or suspension of melamine/formaldehyde precondensates and optionally one or more additional components (Z) may be foamed continuously, preferably discontinuously, at a temperature of 0 to 200° C., preferably 10 to 150° C., under a pressure of 10 to 950 mbar, preferably 50 to 900 mbar, and finally dried, with blowing agents and water that have remained in the foam being removed.

The energy can be introduced by electromagnetic radiation, as for example by high-frequency irradiation with 5 to 400 kW, preferably 5 to 200 kW, more preferably 9 to 120 kW per kilogram of mixture used, in a frequency range from 0.2 to 100 GHz, preferably 0.5 to 10 GHz. A suitable radiation source for dielectric radiation is magnetrons, and irradiation may be carried out with one or more magnetrons at the same time.

Suitable melamine/formaldehyde precondensates are precondensates produced in-house (see review texts: a) W. Woebcken, Kunststoffhandbuch 10. Duroplaste, Munich, Vienna 1988, b) Encyclopedia of Polymer Science and Technology, 3rd ed., vol.1, chapter on Amino Resins, pp. 340-370, 2003, c) Ullmann's Encyclopedia of Industrial Chemistry, 6th ed., vol. 2, chapter on Amino Resins, pp. 537-565, Weinheim 2003) or commercial precondensates of the two components melamine and formaldehyde. The melamine-formaldehyde precondensates generally have a molar ratio of formaldehyde to melamine of 5:1 to 1.3:1, preferably 3.5:1 to 1.5:1.

These melamine/formaldehyde condensation products, further to melamine, may comprise 0% to 50% by weight, preferably 0% to 20% by weight, of other thermoset-resin formers and, further to formaldehyde, 0% to 50% by weight, preferably 0% to 20% by weight, of other aldehydes in cocondensed form. Preference, though, is given to an unmodified melamine/formaldehyde condensation product.

As thermoset-resin formers it is possible to use, for example, alkyl- and aryl-substituted melamine, urea, urethanes, carboxamides, dicyandiamide, guanidine, sulfurylamide, sulfonamides, aliphatic amines, glycols, and phenol and its derivatives.

As aldehydes it is possible to use, for example, acetaldehyde, trimethylolacetaldehyde, acrolein, benzaldehyde, furfural, glyoxal, glutaraldehyde, phthalaldehyde and terephthalaldehyde. Further details concerning melamine/formaldehyde condensation products are found in Houben-Weyl, Methoden der organischen Chemie, volume 14/2, 1963, pages 319 to 402.

In another preferred embodiment, the melamine/formaldehyde precondensate is present in the mixture in an amount of from 55% to 85% by weight, preferably from 63% to 80% by weight.

In the course of the preparation of the melamine/formaldehyde precondensate it is possible to add alcohols, examples being methanol, ethanol or butanol, in order to obtain partially or completely etherified condensates. The formation of ether groups can be used to influence the solubility of the melamine/formaldehyde precondensate and the mechanical properties of the completely cured material.

The amount of blowing agent may be varied within wide ranges and is guided in general by the desired density of the foam to be produced. The amount of blowing agent is generally 1% to 40% by weight, preferably 1.5% to 30% by weight, more preferably 5% to 15% by weight, based on the melamine/formaldehyde precondensate.

The curatives may be used in general in amounts from 0.01% to 20% by weight, preferably 0.02% to 10% by weight, more preferably 0.05% to 5% by weight, based on the melamine/formaldehyde precondensate.

The adjuvants may be used in general in amounts from 0% to 20% by weight, preferably 0% to 10% by weight, more preferably 0% to 5% by weight, more particularly 0% by weight, based on the melamine/formaldehyde precondensate.

Suitable dispersants and/or emulsifiers include anionic, cationic, and nonionic surfactants and mixtures thereof.

Examples of suitable anionic surfactants include diphenylene oxide sulfonates, alkylsulfonates and alkylbenzenesulfonates, alkylnaphthalenesulfonates, alkyl ether sulfonates, fatty alcohol sulfates, ether sulfates, acylaminoalkanesulfonates, acylisothionates, alkyl ether carboxylates, N-acylsarcosinates, and alkyl phosphates and alkyl ether phosphates.

Examples of cationic emulsifiers that can be used include alkyltriammonium salts, alkylbenzyldimethylammonium salts, and alkylpyridinium salts.

Examples of suitable nonionic surfactants include alkylphenol polyglycol ethers, fatty alcohol polyglycol ethers, fatty acid polyglycol ethers, fatty acid alkanolamides, ethylene oxide/propylene oxide block copolymers, amine oxides, glyceryl fatty acid esters, sorbitan esters, and alkylpolyglycosides.

Suitable blowing agents include “physical” or “chemical” blowing agents (Encyclopedia of Polymer Science and Technology, vol. 1, 3rd edn., chapter on Additives, pages 203 to 218, 2003).

Examples of suitable “physical” blowing agents include hydrocarbons, such as pentane, hexane, halogenated, especially chlorinated and/or fluorinated, hydrocarbons, examples being methylene chloride, chloroform, trichloroethane, hydrochlorofluorocarbons, partially halogenated hydrochlorofluorocarbons (H-CFCs), alcohols, examples being methanol, ethanol, n-propanol, and isopropanol, ethers, ketones, and esters, examples being methyl formate, ethyl formate, methyl acetate, and ethyl acetate, in liquid form, or air, nitrogen, and carbon dioxide as gases.

Examples of suitable “chemical” blowing agents include isocyanates in a mixture with water, releasing carbon dioxide as active blowing agent. Additionally suitable are carbonates and bicarbonates in a mixture with acids, again generating carbon dioxide. Also suitable are azo compounds, such as azodicarbonamide, for example.

Curatives used may be acidic (acid) compounds which catalyze the further condensation of the melamine resin. The amount of these curatives is generally 0.01% to 20% by weight, preferably 0.05% and 5% by weight, based in each case on the precondensate. Suitable acidic compounds are organic and inorganic acids, selected for example from the group consisting of hydrochloric acid, sulfuric acid, phosphoric acid, nitric acid, formic acid, acetic acid, oxalic acid, toluenesulfonic acids, amidosulfonic acids, acid anhydrides, and mixtures thereof.

In another embodiment, the mixture is free from further adjuvants. For certain purposes, however, it may be advantageous to add 0.1% to 20% by weight, preferably 0.1% to 10% by weight, based on the melamine/formaldehyde precondensate, of usual adjuvants, such as dyes, flame retardants, UV stabilizers, agents for reducing the toxicity of fire gases or for promoting carbonization.

It is also possible to add adjuvants to the melamine/formaldehyde precondensate. In one embodiment, the foams comprise at least one adjuvant from the group consisting of dyes, fragrances, optical brighteners, UV absorbers, and pigments. Said adjuvant is preferably distributed homogeneously within the foam.

Pigments used may be common inorganic natural pigments (chalk for example) or synthetic pigments (titanium oxides for example), but also organic pigments.

The density of the melamine resin foams which can be produced in accordance with the invention is situated in general at 3 to 50 g/l [g per liter], preferably 4 to 20 g/l, more preferably 5 to 10 g/l.

The melamine resin foams producible in accordance with the invention may be foamed to any forms, preferably shaped parts of any form, finite sheets or continuous sheets, more preferably finite or continuous sheets in—generally—any desired thickness, advantageously in layer thicknesses from 0.1 to 500 cm, preferably 0.5 to 200 cm, more preferably 1 to 100 cm, more particularly 3 to 80 cm, and very preferably 5 to 50 cm.

The melamine resin foams producible in accordance with the invention, and also the hydrophobic melamine resin foams producible in accordance with the invention, in the form of continuous or finite sheets, shaped parts or any other configuration, may be provided or laminated by generally conventional methods on one, two, more than two or all sides with face layers, as for example with paper, paperboard, glass veil, wood, gypsum board, metal sheets or metal foils, plastic or plastics films, which if desired may also be foamed. The face layers may be applied during the foaming operation or subsequently. In the case of subsequent application, it is advantageous to use an adhesion promoter.

The melamine resin foams of the invention find application in the cushioning of seat areas, as heat, cold and/or sound protection or insulation/encapsulation of buildings and parts of buildings, more particularly walls, partitions, roofs, facades, doors, ceilings, and floors, of vehicles of any kind on land, on water, in the air and in space, whether for transporting cargo or people, or any such combination in passenger cars, trucks, as for example for insulating the engine compartment (such as engine hoods) or passenger cells, in rail traffic in the rail cars in transportation of goods or people, and also in locomotives, in aircraft, as for example in the cabin interior, in the cockpit or cargo hold, and also in space travel in manned or unmanned flying objects such as spaceships and space gliders, space capsules or satellites, for low-temperature insulation for example of cooling assemblies, refrigerators, cold stores, tank systems and containers for any desired liquids, more particularly for oil and gas or liquefied gas down to (−278)° C., for storage and in transportation, for absorption and completely or partially reversible release of liquids down to (−278)° C., as “sponge” in the cleaning industry for the cleaning of surfaces, in the form of sponges, for example, or saturated with cleaning agents of any kind, including for washing operations in (fully) automatic washing machines, as shock-dampening or shock-insulating packaging material, for sound absorption and heat insulation of buildings, and for producing cleaning sponges.

An elastic foam of this kind which is manufactured industrially and is based on a melamine/formaldehyde condensate is known under the trade name BASOTECT® (from BASF SE).

### EXAMPLES

### Examples 1 to 5

75 parts by weight of the spray-dried melamine/formaldehyde precondensate from example A (molar ratio 1:3) were dissolved in 25 parts by weight of water. This resin solution was admixed with 3% by weight of formic acid, 2% by weight of an Na C₁₂/C₁₈ alkane sulfate and 20% by weight of pentane, based in each case on the melamine/formaldehyde precondensate, and the mixture was stirred and then foamed in a cylindrical polyaryl ether ketone (PEEK) pressure mold by injection of microwave energy. After foaming, drying was carried out for 30 minutes. The pressures can be set variably between 0.1 mbar and 1013 mbar.

The results are summarized in table 1.

TABLE 1

| | Pressure | | Density | |
|---|---|---|---|---|
| Example | [mbar] | Description | [g/l] | Ram pressure Fₘₐₓ [N/KN] |
| 1 | 1013 | elastic | 8.9 | 12.3 |
| 2 | 920 | elastic | 8.9 | 16.0 |
| 3 | 500 | elastic | 8.6 | 20.6 |
| 4 | 250 | elastic | 8.3 | 27.1 |
| 5 | 50 | elastic | 7.5 | 35.9 |

Ram pressure measurement (as per U.S. Pat. No. 4,666,948) for assessing the mechanical quality of the melamine resin foams.

For this purpose a cylindrical ram having a diameter of 8 mm and a height of 10 cm was pressed into a cylindrical sample with a diameter of 11 cm and a height of 5 cm, in the direction of foaming, at an angle of 90° until the sample tears. The tearing force (N/KN) provides information on the quality of the foam.

1-6. (canceled)

7. A process for producing a molded foam from melamine/formaldehyde condensation products, which comprises subjecting melamine/formaldehyde precondensates to foaming under reduced pressure and subsequent irradiation.

8. The process for producing a molded foam from melamine/formaldehyde condensation products according to claim 7, wherein foaming takes place at a temperature from 0 to 200° C.

9. The process for producing a molded foam from melamine/formaldehyde condensation products according to claim 7, wherein foaming takes place at a pressure from 10 to 950 mbar.

10. The process for producing a molded foam from melamine/formaldehyde condensation products according to claim 7, wherein drying takes place after foaming.

11. A molded foam comprising melamine/formaldehyde condensation products, produced according to claim 7.
